(19) United States
(12) Patent Application Publication
(10) Pub. No.: US 2023/0121859 A1
(43) Pub. Date: Apr. 20, 2023

(54) DRONE

(71) Applicant: Takafuji Research Institute, Inc., Yokohama (JP)

(72) Inventors: Yasutane TAKAFUJI, Yokohama (JP); Katsuji KAWANISHI, Toyohashi (JP)

(21) Appl. No.: 17/966,578

(22) Filed: Oct. 14, 2022

(30) Foreign Application Priority Data
Oct. 14, 2021 (JP) 2021-168510

(51) Int. Cl. B64C 39/02; H02J 7/00; H02K 7/00; H02K 7/14; H02K 11/33; H02K 1/26; B64D 35/00; B64D 27/24; B64D 31/00

(52) U.S. Cl. CPC B64C 39/024; H02J 7/0068; H02J 7/0063; H02K 7/003; H02K 7/14; H02K 11/33; H02K 1/26; B64D 35/00; B64D 27/24; B64D 31/00; B64C 2201/108; B64C 2201/042

(57) ABSTRACT

The drone according to the embodiment has a propeller, a first direct current motor, a power source, a second direct current motor, and a control unit. The first direct current motor drives the propellers. The power source supplies power to the first direct current motor. The second direct current motor has a rotating shaft that rotates in conjunction with the rotation of a rotating shaft of the first direct current motor. The control unit controls the first direct current motor. The second direct current motor charges the power source using the current output from the second direct current motor along with the rotation of a rotating shaft of the second direct current motor.

### TECHNICAL FIELD

The embodiment of the present invention relates to a drone.

### BACKGROUND ART

In recent years, drones have been used in many fields. For example, by mounting a camera on a drone and remotely controlling it, imaging is performed in locations where a large manned helicopter cannot fly. Demonstration tests of a home delivery service using drones are also underway.

A drone drives a propeller and flies using a storage battery installed therein. In order to extend the flight time of drones, it is necessary to increase the capacity of storage batteries. However, the greater the capacity, the heavier the weight of the storage battery. In order to fly with a mounted heavy storage battery, a large propeller and a large motor are required, and there is a problem in that the manufacturing cost of a drone increases. Extending drone flight time is a major challenge.

### PRIOR ART DOCUMENTS

### Patent Documents

[Patent Document 1] Japanese Unexamined Patent Application Publication No. 2021-118418

### SUMMARY OF INVENTION

### Problem to be Solved by Invention

In light of the above, an object of the present invention is to extend the flight time of a drone.

### Means for Solving Problem

To resolve the above problem, the drone according to the embodiment has a propeller, a first direct current motor, a power source, a second direct current motor, and a control unit. The first direct current motor drives the propellers. The power source supplies power to the first direct current motor. The second direct current motor has a rotating shaft that rotates in conjunction with the rotation of a rotating shaft of the first direct current motor. The control unit controls the first direct current motor. The second direct current motor charges the power source using the current output from the second direct current motor along with the rotation of a rotating shaft of the second direct current motor.

### BRIEF DESCRIPTION OF DRAWINGS

FIG. 1 An external view of the drone according to an embodiment.

FIG. 2 A block diagram of the drone according to an embodiment.

FIG. 3 A configuration diagram of a power source according to an embodiment.

FIG. 4 A perspective view of a drive unit according to an embodiment.

FIG. 5 A perspective view of a feedback unit according to an embodiment.

FIG. 6 A diagram for describing a connection portion according to an embodiment.

FIG. 7 A diagram for describing a drone according to an embodiment.

FIG. 8 A circuit for measuring the output voltage of a feedback unit according to an embodiment.

FIG. 9 A diagram for describing measurement results.

### MODE FOR CARRYING OUT THE INVENTION

Below, a drone according to an embodiment will be described with reference to drawings. An XYZ coordinate system composed of an X-axis, a Y-axis, and a Z-axis orthogonal to each other is appropriately used for description.

### Embodiment 1

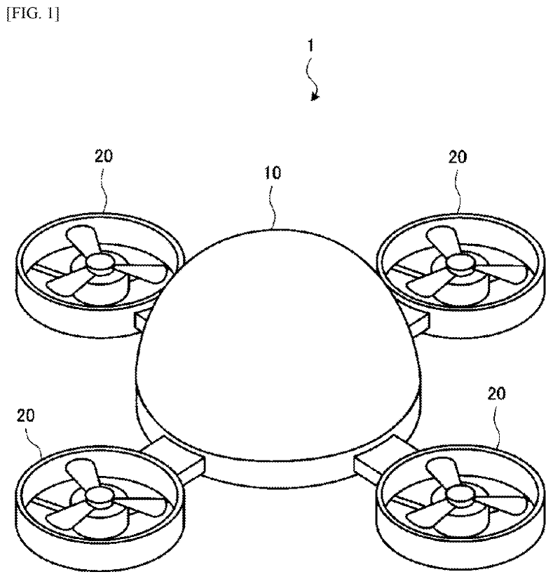

FIG. 1 is an external view of a drone 1 according to an embodiment. The drone 1 has a drone main body 10 and a plurality of propellers 20. In FIG. 1, a case is described wherein there are four propellers 20, but the number of propellers 20 is not limited thereto. A power source, control unit, and the like are mounted on the drone main body 10.

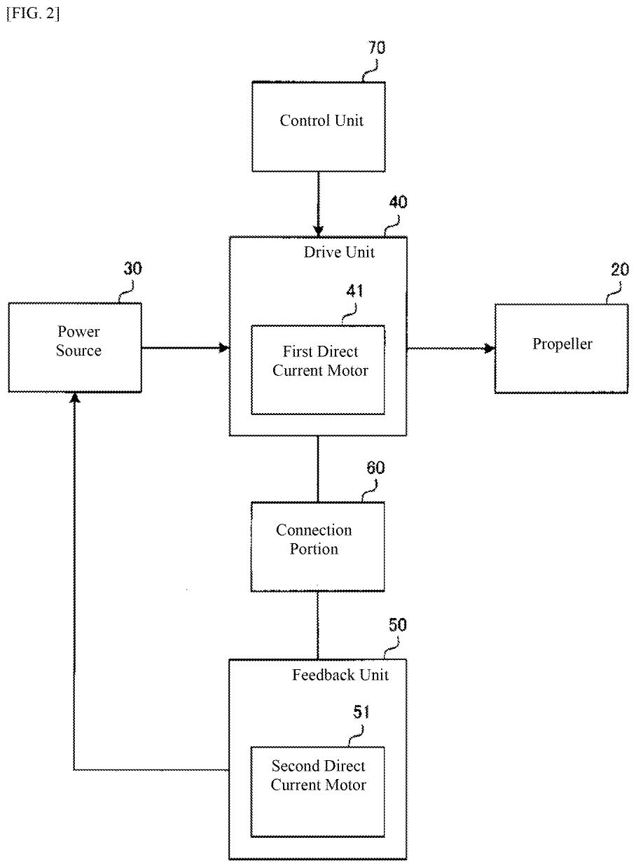

FIG. 2 is a block diagram of the drone 1 according to an embodiment. The drone 1 has a power source 30, a drive unit 40, a propeller 20, a feedback unit 50, a connection portion 60, and a control unit 70.

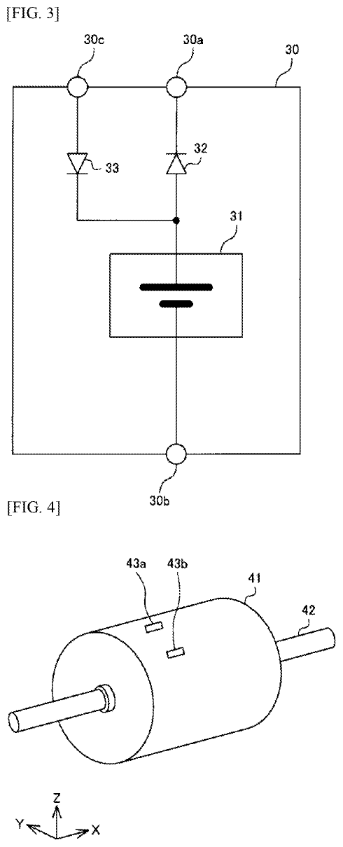

FIG. 3 is a configuration diagram of the power source 30. The power source 30 has a rechargeable storage battery 31, a diode 32, and a diode 33 in the interior thereof. The diode 32 and the diode 33 are current direction limiting elements for limiting the direction of current. The diode 33 limits the current flowing from the storage battery 31 to a winding wound around a rotor of a second direct current motor 51 configuring the feedback unit 50. Note that the diode 32 may be omitted. The power source 30 has terminals 30a, 30b, and 30c. The storage battery 31 applies a direct current voltage to the drive unit 40 via the terminals 30a and 30b. The storage battery 31 is charged by the feedback unit 50 via the terminals 30c and 30b.

Returning to FIG. 2, the drive unit 40 is configured by a first direct current motor 41. FIG. 4 is a perspective view of the first direct current motor 41 configuring the drive unit 40. The first direct current motor 41 drives the propellers 20. The first direct current motor 41 is provided respectively on the plurality of propellers 20. Here, because four propellers 20 are mounted on the drone 1, the drive unit 40 is provided with four first direct current motors 41. The first direct current motor 41 has a rotating shaft 42 whose axial direction is the X-axis direction. A three-pole type rotor is fixed to the rotating shaft 42, and a winding is wound around the rotor. One end of the winding wound around the rotor is connected to a terminal 43a, and the other end is connected to a terminal 43b. The terminal 43a is connected to the terminal 30a of the power source 30, and the terminal 43b is connected to the terminal 30b of the power source 30. The first direct current motor 41 is provided with a stator (magnet) disposed so as to cover the rotor. The rotor rotates in a magnetic field formed by the stator with the rotating shaft 42 as the axis thereof.

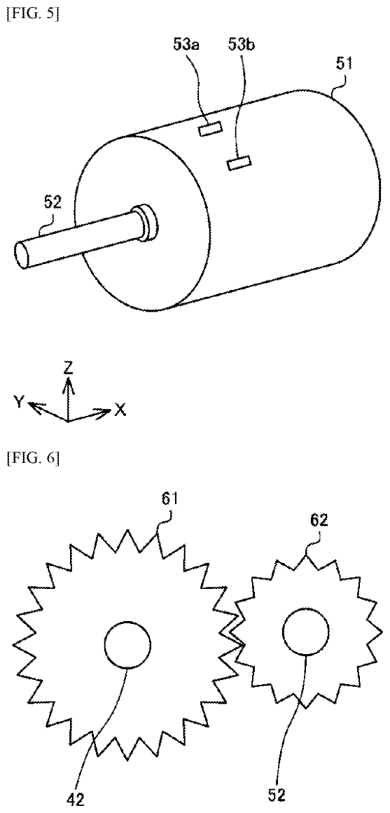

Returning to FIG. 2, the feedback unit 50 is configured by the second direct current motor 51. FIG. 5 is a perspective view of the second direct current motor 51 configuring the feedback unit 50. The second direct current motor 51 is provided corresponding to the first direct current motor 41. Here, because the drive unit 40 is provided with four first direct current motors 41, the feedback unit 50 is provided with four second direct current motors 51. The second direct current motor 51 has a rotating shaft 52 whose axial direction is the X-axis direction, that rotates in conjunction with the rotation of the rotating shaft 42 of the first direct current motor 41. A three-pole type rotor is fixed to the rotating shaft 52, and a winding is wound around the rotor. One end of the winding wound around the rotor is connected to a terminal 53a, and the other end is connected to a terminal 53b. The second direct current motor 51 is provided with a stator (magnet) disposed so as to cover the rotor. The rotor rotates in a magnetic field formed by the stator with the rotating shaft 52 as the axis thereof. The second direct current motor 51 generates current in the winding wound around the rotor due to the rotor rotating in the magnetic field formed by the stator. Here, the terminal to which one end having the higher potential of voltage generated at both ends of the winding is the terminal 53a, and the terminal to which the other end having the lower potential is connected is the terminal 53b. The terminal 53a is connected to the terminal 30c of the power source 30, and the terminal 53b is connected to the terminal 30b of the power source 30. Returning to FIG. 2, the connection portion 60 transfers the rotation of the rotating shaft 42 of the first direct current motor 41 to the rotating shaft 52 of the second direct current motor 51. FIG. 6 is a diagram for describing the connection portion 60. The connection portion 60 is made up of a first gear 61 and a second gear 62. The first gear 61 is provided fit into the rotating shaft 42 of the first direct current motor 41. The second gear 62 is provided fit into the rotating shaft 52 of the second direct current motor 51. The first gear 61 and the second gear 62 are disposed being fit together, and the second gear 62 rotates in conjunction with the rotation of the first gear 61. The ratio of the number of teeth on the first gear 61 and the number of teeth on the second gear 62 is represented by N.

Returning to FIG. 2, the control unit 70 is configured by a communication unit, a CPU, a RAM, a ROM, and the like. A program for controlling the drone 1 is stored in a ROM. The control unit 70 controls the flight of the drone 1 by driving the propellers 20 by controlling the drive unit 40 based on control information received by the communication unit. More specifically, the control unit 70 interposes an electronic switch or resistor between the power source 30 and the drive unit 40 and controls the current supplied to the first direct current motor 41 configuring the drive unit 40 to control the respective rotation speed or the turning on and turning off of rotation of the plurality of first direct current motors 41.

Next, the operation of the drone 1 will be described. The control unit 70 drives the propellers 20 by controlling the drive unit 40 based on the control information received by the communication unit. The drone 1 flies due to the rotation of the propellers 20.

The rotating shaft 42 of the first direct current motor 41 configuring the drive unit 40 illustrated in FIG. 4 rotates when power is supplied from the power source 30. More specifically, the rotating shaft 42 of the first direct current motor 41 rotates due to a force that the winding wound around the rotor configuring the first direct current motor 41, this winding having current flowing therein, receives from the magnetic field formed by the stator (permanent magnet) configuring the first direct current motor 41, based on Fleming's rule. The larger the current flowing in the winding, the larger the rotation speed of the rotating shaft 42 that can be obtained. Furthermore, the stronger the magnetic force of the permanent magnet, the greater the rotation speed of the rotating shaft 42 that can be obtained. Moreover, when the current that flows in the first direct current motors 41 are the same and the number of windings is the same, the longer a length C1 of the winding wound around the rotor configuring the first direct current motor 41, the greater the rotation speed the rotating shaft 42 can obtain.

The rotating shaft 52 of the second direct current motor 51 rotates at a rotation speed according to the rotation speed of the rotating shaft 42 of the first direct current motor 41 and the ratio N of the number of teeth of the first gear 61 of the connection portion 60 and the number of teeth of the second gear 62. By the winding wound around the rotor fixed to the rotating shaft 52 rotating in the magnetic field formed by the stator (permanent magnet) configuring the second direct current motor 51, current that is proportional to the rotation speed of the rotating shaft 52 is generated in the winding would around the rotor of the second direct current motor 51, based on Fleming's rule. The greater the length C2 of the winding wound around the rotor configuring the second direct current motor 51, the greater the current generated by the second direct current motor 51. Furthermore, the faster the rotation speed of the rotating shaft 52 of the second direct current motor 51, the greater the current generated by the second direct current motor 51. The second direct current motor 51 charges the power source 30 using the generated current.

### MODIFIED EXAMPLES

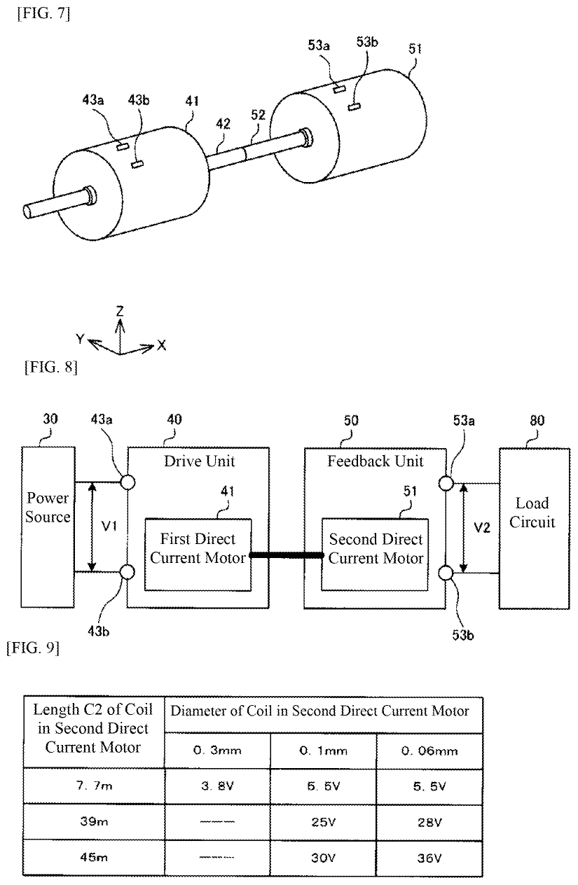

In the description above, an example was described wherein the first direct current motor 41 rotates the rotating shaft 52 of the second direct current motor 51 via the connection portion 60 made up of the first gear 61 and the second gear 62. However, the connection portion 60 can be omitted. For example, as illustrated in FIG. 7, the end portion of the rotating shaft 42 of the first direct current motor 41 on the +X side and the end portion of the rotating shaft 52 of the second direct current motor 51 on the −X side are directly connected. Alternatively, the rotating shaft 42 of the first direct current motor 41 may be made longer and the rotor of the second direct current motor 51 may be fixed to the rotating shaft 42.

### (Measurement Results)

Next, measurement results of measuring the relationship between the length C1 of the winding wound around the rotor configuring the first direct current motor 41 and the length C2 of the winding wound around the rotor configuring the second direct current motor 51, and the output voltage of the second direct current motor 51 configuring the feedback unit 50 will be described. FIG. 8 is a measurement circuit used for measurement. As illustrated in FIG. 8, the connection portion 60 is omitted in the measurement circuit. That is, as illustrated in FIG. 7, the end portion of the rotating shaft 42 of the first direct current motor 41 on the +X side and the end portion of the rotating shaft 52 of the second direct current motor 51 on the −X side are directly connected.

In the measurement circuit illustrated in FIG. 8, a direct current voltage of V1=6V is applied from the power source 30 to the terminal 43a and the terminal 43b of the first direct current motor 41 configuring the drive unit 40. As a load circuit 80, a resistor of 10 kΩ is connected to the terminal 53a and the terminal 53b of the second direct current motor 51. The voltage of both ends of the load circuit 80 was measured as the output voltage V2 of the second direct current motor 51.

The first direct current motor 41 is created by a winding having a length C1=7.7 m and a diameter of 0.3 mm. The winding is wound by hand around a three-pole type rotor. A plurality of the second direct current motors 51 having different lengths C2 and diameters of the winding were created and the output voltage of the second direct current motors 51 were measured.

FIG. 9 illustrates the measurement results. From the measurement results, it can be understood that the output voltage of the second direct current motor 51 tends to be higher the greater the length C2 of the winding of the second direct current motor 51. This means that the greater the length C2 of the winding of the second direct current motor 51 crossing through the magnetic flux formed by the stator (permanent magnet) of the second direct current motor 51, the greater the current generated in the winding of the second direct current motor 51 due to Fleming's rule. The output voltage is a value found by multiplying the value of load resistance by the generated current. Therefore, it is thought that the output voltage of the second direct current motor 51 increases the greater the length C2 of the winding of the second direct current motor 51.

Moreover, from the measurement results, the output voltage of the second direct current motor 51 tends to be higher the smaller the diameter of the winding of the second direct current motor 51. It is assumed that this is because the smaller the diameter of the winding, the closer the distance between the winding of the second direct current motor 51 and the permanent magnet that is a stator. The closer the distance between the winding and the permanent magnet that is a stator, the stronger the magnetic field through which the winding moves. Therefore, the smaller the diameter of the winding, the stronger the magnetic field through which the winding moves, and it is thought that a larger current will be generated in the winding due to Fleming's rule.

As described above, the drone 1 according to the embodiment has a propeller 20, a first direct current motor 41 for driving the propeller 20, a power source 30 for supplying power to the first direct current motor 41, a second direct current motor 51 having a rotating shaft 52 that rotates in conjunction with the rotation of a rotating shaft 42 of the first direct current motor 41, and a control unit 70 for controlling the first direct current motor 41. The second direct current motor 51 charges the power source 30 using the current output from the second direct current motor 51 along with the rotation of the rotating shaft 52 of the second direct current motor 51. The drone 1 according to the embodiment can have an extended flight time by feeding back a portion of the rotational energy from the first direct current motor 41 to the power source 30 via the second direct current motor 51.

Moreover, the drone 1 according to the embodiment can determine the size of the current charged from the second direct current motor 51 to the power source based on the ratio of the length C1 of the winding wound around the rotor configuring the first direct current motor 41 and the length C2 of the winding wound around the rotor configuring the second direct current motor 51.

Furthermore, the drone 1 according to the embodiment can determine the size of the current charged from the second direct current motor 51 to the power source based on the ratio between the number of teeth of the first gear 61 configuring the connection portion 60 and the number of teeth of the second gear 62.

Note that in the above description, the configuration of the power source 30 has been described in a simple manner using FIG. 3, but the configuration of the power source 30 to enable charging and discharging is not limited thereto.

A number of embodiments of the present invention have been described, but these embodiments are presented as examples and are not intended to limit the scope of the invention. These new embodiments may be implemented in various other forms, and various omissions, substitutions, and changes may be made to the extent that they do not deviate from the main points of the invention. These embodiments and modifications thereof are included in the scope and summary of the invention and are also included in the scope of the invention and the equivalent thereof described in the Scope of Patent Claims.

### DESCRIPTION OF REFERENCE NUMERALS

1 . . . Drone
10 . . . Drone main body
20 . . . Propeller
30 . . . Power source
31 . . . Storage battery
32, 33 . . . Diode (current control element)
40 . . . Drive unit
41 . . . First direct current motor
42 . . . Rotating shaft of first direct current motor
50 . . . Feedback unit
51 . . . Second direct current motor
52 . . . Rotating shaft of second direct current motor
60 . . . Connection portion
61 . . . First gear
62 . . . Second gear
70 . . . Control unit
80 . . . Load circuit

1. A drone,
comprising:
a propeller,
a first direct current motor for driving the propeller,
a power source for supplying power to the first direct current motor,
a second direct current motor having a rotating shaft that rotates in conjunction with the rotation of a rotating shaft of the first direct current motor, and
a control unit for controlling the first direct current motor, wherein:
the second direct current motor charges the power source using current output from the second direct current motor along with the rotation of the rotating shaft of the second direct current motor.

2. The drone according to claim 1, wherein:
the rotating shaft of the first direct current motor and the rotating shaft of the second direct current motor are formed by one rotating shaft.

3. The drone according to claim 1, wherein:
the current output from the second direct current motor is determined based on the ratio of the length of a winding wound around a rotor configuring the first direct current motor and the length of a winding wound around a rotor configuring the second direct current motor.

4. The drone according to claim 1, comprising:
a connection portion for transferring the rotation of the rotating shaft of the first direct current motor to the rotating shaft of the second direct current motor.

5. The drone according to claim 4, wherein:
the connection portion:
is configured comprising:
a first gear fit into the rotating shaft of the first direct current motor, and
a second gear fit into the rotating shaft of the second direct current motor, wherein:
the current output by the second direct current motor is determined based on the ratio of the length of a winding wound around a rotor configuring the first direct current motor and the length of a winding wound around a rotor configuring the second direct current motor, and the ratio between the number of teeth of the first gear and the number of teeth of the second gear.
